(19) United States
(12) Patent Application Publication
(10) Pub. No.: US 2007/0024225 A1
(43) Pub. Date: Feb. 1, 2007

(54) ELECTRONICALLY COMMUTATED MOTOR (ECM) AND METHOD OF CONTROLLING AN ECM

(76) Inventors: Alexander Hahn, Sauldorf (DE); Harald Schmid, Emmigen (DE); Michael Kisch, St. Georgen (DE)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/457,532

(22) Filed: Jul. 14, 2006

(30) Foreign Application Priority Data
Jul. 28, 2005 (DE) 10 2005 036 651.1

(51) Int. Cl. H02P 7/00

(52) U.S. Cl. 318/434; 318/439

(57) ABSTRACT

An electronically commutated motor comprises a rotor (208); a stator (201) electromagnetically interacting with the rotor (208), which stator is formed with a stator winding (202, 204, 206); a power stage (122) controlling the currents flowing in the stator winding (202, 204, 206) during operation; at least one current measuring element (242, 244) for sensing a measured value for the currents (I_UPPER, I_LOWER) flowing in the power stage, and an overcurrent measuring element (152, 162) for evaluating an associated measured value and for sensing a current whose absolute value exceeds a predetermined limit value (I_MAX_UPPER, I_MAX_LOWER); a holding element (154, 164) associated with the overcurrent measuring element (152, 162), configured, when an overcurrent occurs in the associated current measuring element (242, 244), to generate an overcurrent signal (OC_UPPER, OC_LOWER), to store the signal, and to deliver a signal to the power stage (122).

### CROSS REFERENCE

This application claims priority from German application DE 10 2005 036 651.1, filed 28 Jul. 2005, the entire content of which is hereby incorporated by reference.

### FIELD OF THE INVENTION

The invention relates to an electronically commutated motor and a method of controlling an electronically commutated motor.

### BACKGROUND

In an electronically commutated motor (ECM), a short circuit occurring during operation of the motor can result in damage to or destruction of an associated power stage. To prevent such damage or destruction, the associated power stage must be protected against possible error states, in particular against short circuit. It is desirable in this context to protect the associated power stage and the ECM, by means of a suitable protective circuit, against a short circuit of the ECM's phases, a short circuit to ground, a short circuit with respect to a corresponding supply voltage of the ECM, a winding short circuit, and/or a power stage short circuit. Motors installed in vehicles are sometimes subjected to harsh environmental conditions, such as varying combinations of water and road salt, which raise the incidence of such short circuits, in spite of best efforts to protect against such environmental conditions.

### SUMMARY OF THE INVENTION

It is an object of the present invention to make available a novel electronically commutated motor (ECM), as well as a novel method of controlling an electronically commutated motor.

The invention is based on the recognition that a short circuit occurring in an ECM produces an overcurrent at a power stage associated with the ECM. An overcurrent of this kind can be detected with suitable overcurrent measuring elements, and a shutoff of the power stage can be produced in reaction to the detection of the overcurrent. By means of a shutoff of the power stage, the motor electronics of the ECM can be protected from damage or destruction by the overcurrent. The invention is not, however, limited to a specific type of motor, but rather is suitable for electric motors of any kind.

The object of the present invention is achieved in particular by means of an electronically commutated motor having an overcurrent detector and a holding element, responsive to the overcurrent detector, for sending a shutoff signal to the power stage. By means of the shutoff of the power stage, the power stage and the motor are protected from damage or destruction by the overcurrent.

A preferred refinement of the motor is one in which the power stage controls current through the stator windings using a full bridge circuit with upper and lower semiconductor switches, and the control circuit responds to an overcurrent signal by making all the upper and lower semiconductor switches non-conductive. In accordance therewith, at least one first overcurrent measuring element is connected to a first measuring resistor arranged between ground and the lower semiconductor switches of the power stage, in order to sense a first signal describing the power-stage current. In addition, at least one second overcurrent measuring element is connected to a second measuring resistor arranged between a supply voltage source and the upper semiconductor switches of the power stage, in order to sense a second signal describing the power-stage current.

With the use of at least two separate overcurrent measuring elements, various types of overcurrent can be reliably recognized. For example, the first overcurrent measuring element can preferably be implemented for detection of an overcurrent that occurs as a consequence of a short circuit to ground, and the second overcurrent measuring element can preferably be implemented for detection of an overcurrent that occurs as a consequence of a short circuit to a corresponding supply lead. Thus, for example, an overcurrent that occurs as a consequence of a short circuit to the positive supply lead, and that cannot be detected by the first overcurrent measuring element, would be detected only by the second overcurrent measuring element; and an overcurrent that occurs as a consequence of a short circuit to ground, and that thus cannot be detected by the second overcurrent measuring element, would be detected only by the first overcurrent measuring element. In both cases, however, a detection of the overcurrent would take place, so that a shutoff of the power stage can be brought about in each case.

The object of the present invention is likewise achieved by a method comprising the steps of measuring one or more currents flowing in the power stage, comparing the measured value(s) to predetermined limit values, taking the absolute value(s) of the amount by which each limit is exceeded, generating and storing an overcurrent signal, and applying the thus-generated signal to the power stage to prevent the overcurrent condition from continuing.

### BRIEF FIGURE DESCRIPTION

Further details and advantageous refinements of the invention are evident from the exemplifying embodiments described below and depicted in the drawings, in which:

FIG. 1 is a block diagram of a preferred embodiment of an Electronically Commutated Motor (ECM) having a short-circuit shutoff system;

FIG. 2 is a simplified circuit diagram of an ECM having a short-circuit shutoff system, according to an embodiment of the invention;

FIG. 3 is a simplified circuit diagram of an apparatus for detecting an overcurrent at a power stage and for generating overcurrent signals in order to shut off the power stage, according to an embodiment of the invention;

FIG. 4 is a simplified circuit diagram of an apparatus for detecting an overcurrent on an upper side of a power stage and for generating overcurrent signals in order to shut off the power stage, according to an embodiment of the invention; and

FIG. 5 is a simplified circuit diagram of an apparatus for shutting off upper and lower semiconductor switches of a power stage in response to an overcurrent signal, according to an embodiment of the invention.

### DETAILED DESCRIPTION

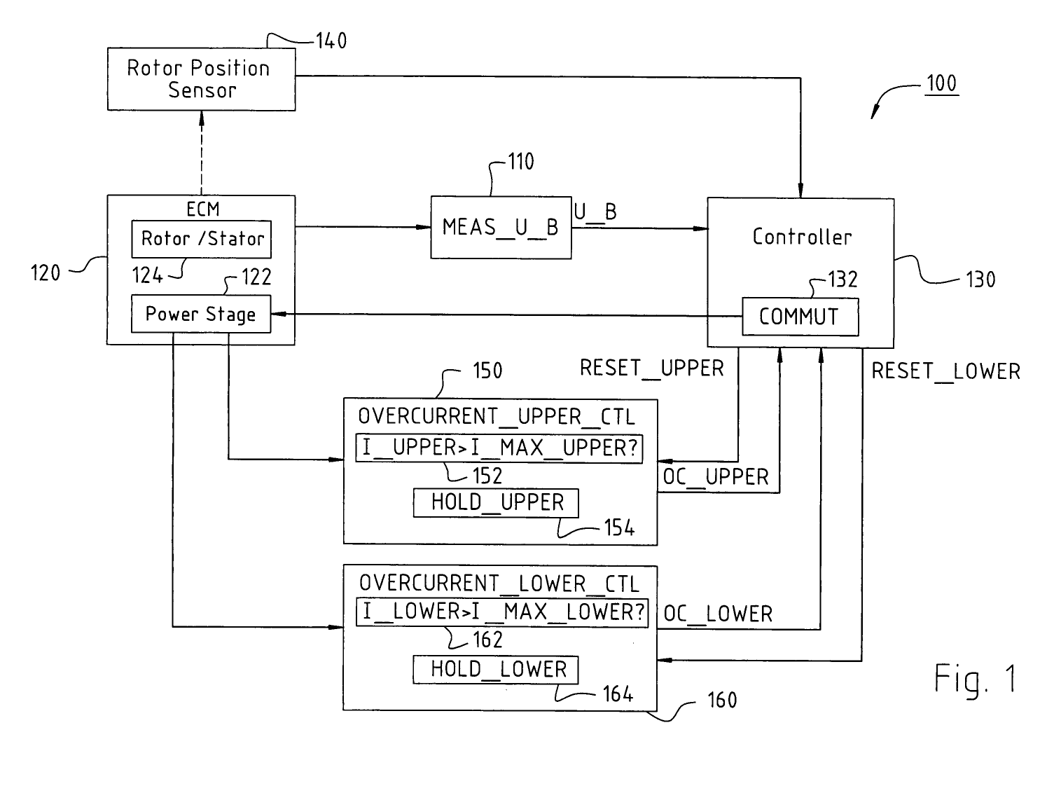

FIG. 1 is a block diagram illustrating, in principle, the functioning of an apparatus 100 according to the present invention for operating an ECM 120 having a short-circuit shutoff system. Apparatus 100 is configured, on the one hand, for detection of an overcurrent occurring as a result of a short circuit in ECM 120. On the other hand, apparatus 100 is configured to shut off ECM 120 in reaction to the detection of the overcurrent, in order to prevent damage to or destruction of ECM 120 by the overcurrent.

According to an embodiment of the present invention, apparatus 100 encompasses an ECM 120 with a rotor/stator arrangement 124 (Rotor/Stator) having a rotor and at least one stator phase. A power stage 122, for influencing the motor current in the at least one stator phase, is associated with ECM 120. Apparatus 100 furthermore encompasses a controller 130 that is connected to ECM 120. Controller 130 encompasses a commutation controller 132 (COMMUT), and is connected at the input side on the one hand to a voltage measuring element 110 (MEAS_U_B) for measuring the supply voltage U_B present at power stage 122, and on the other hand to at least one rotor position sensor 140 that is associated with ECM 120. Commutation controller 132 generates commutation signals for power stage 122 of ECM 120 as a function of rotor position signals that are made available by rotor position sensor 140.

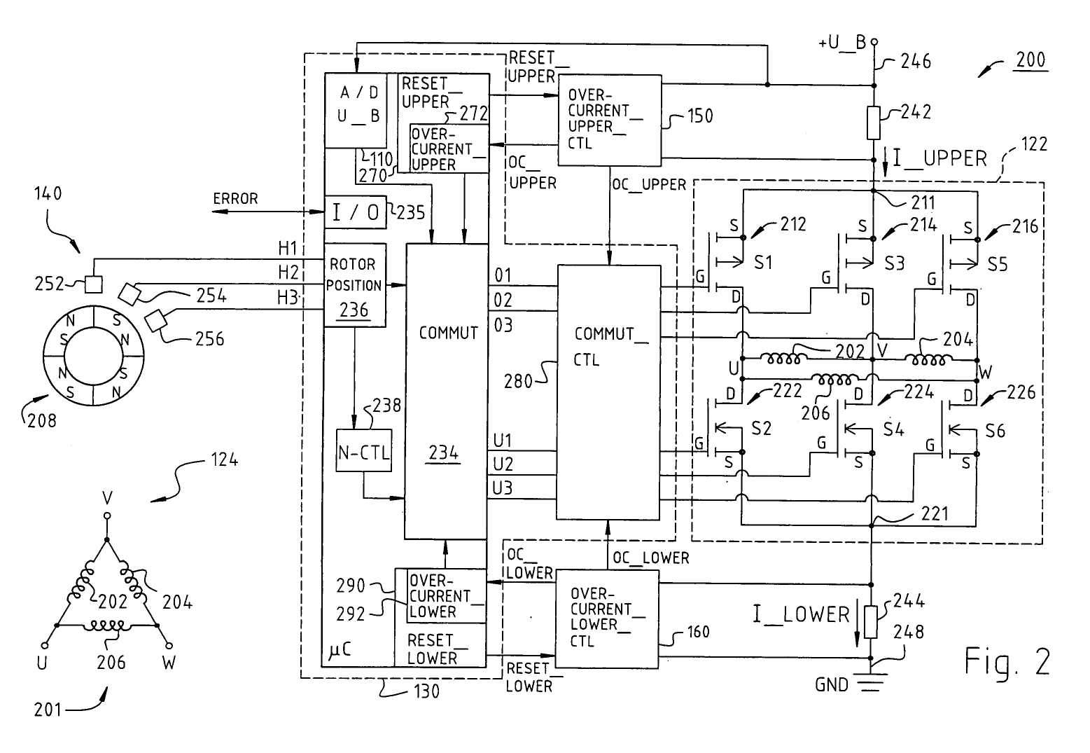

Power stage 122 is connected at the output side to controller 130 via a first overcurrent controller 150 (OVERCURRENT_UPPER_CTL) and a second overcurrent controller 160 (OVERCURRENT_LOWER_CTL). First overcurrent controller 150 is connected to a side of power stage 122 that has the higher potential with reference to a corresponding supply voltage delivered to ECM 120, for example +U_B (cf. FIG. 2). For simplification, this side of power stage 122 is referred to hereinafter as the “upper side.” Second overcurrent controller 160 is connected to a side of power stage 122 that has the lower potential with respect to the corresponding supply voltage delivered to ECM 120, for example ground (cf. FIG. 2). For simplification, this side of power stage is referred to hereinafter as the “lower side.”

FIG. 2 shows an example of power stage 122 of an ECM having three stator phases 202, 204, 206. Power stage 122 has upper MOSFETs (Metal Oxide Semiconductor Field Effect Transistors) 212, 214, 216 that are connected via an upper measuring resistor 242 to a supply voltage U_B, and it has three lower MOSFETs 222, 224, 226 that are connected via a lower measuring resistor 244 to ground. Power stage 122 is described in more detail below with reference to FIG. 2.

First overcurrent controller 150 encompasses, according to FIG. 1, an overcurrent measuring element 152 (I_UPPER>I_MAX_UPPER?) for detecting an overcurrent on the “upper side” of power stage 122, and a holding element 154 (HOLD_UPPER) for generating and holding an overcurrent signal OC UPPER that is delivered to controller 130.

Second overcurrent controller 160 encompasses an overcurrent measuring element 162 (I_LOWER>I_MAX_LOWER?) for detecting an overcurrent on the “lower side” of power stage 122, and a holding element 164 (HOLD LOWER) for generating and holding an overcurrent signal OC_LOWER that is likewise delivered to controller 130. A signal RESET_UPPER can be delivered from controller 130 to overcurrent controller 150, in order to reset holding element 154. A signal RESET_LOWER can furthermore be delivered from controller 130 to overcurrent controller 160 in order to reset holding element 164.

When apparatus 100 is in operation, operating voltage U_B is delivered to the at least one stator phase of rotor/stator arrangement 124 of ECM 120. The currents flowing through the at least one stator phase are controlled by the commutation signals furnished by commutation controller 132 to power stage 122.

Upon the occurrence of an overcurrent at power stage 122, this is detected by overcurrent measuring element 152 of overcurrent controller 150 and/or by overcurrent measuring element 162 of overcurrent controller 160. In overcurrent measuring element 152, an actual current value (I_UPPER) ascertained on the “upper side” of power stage 122 is compared with a maximum actual current value (I_MAX_UPPER) permissible on the “upper side.” If the ascertained actual current value exceeds the maximum permissible actual current value (I_UPPER>I_MAX_UPPER), overcurrent measuring element 152 detects the difference between these two actual current values as an overcurrent, and delivers to holding element 154 a signal characterizing that overcurrent.

In overcurrent measuring element 162, an actual current value (I_LOWER) ascertained on the “lower side” of power stage 122 is compared with a maximum actual current value (I MAX LOWER) permissible on the “lower side.” If the ascertained actual current value on the “lower side” exceeds the maximum actual current value permissible on the “lower side” (I_LOWER>I_MAX_LOWER), overcurrent measuring element 162 detects the difference between these two actual current values as an overcurrent, and delivers to holding element 164 a signal characterizing that overcurrent.

Be it noted that each of the two overcurrent measuring elements 152 and 162 can be implemented to detect a specific type of overcurrent. Because of the arrangement of overcurrent controller 150 on the “upper side” of power stage 122, for example, overcurrent measuring element 152 can preferably be configured for detecting an overcurrent that occurs as a consequence of a short circuit to a corresponding supply lead.

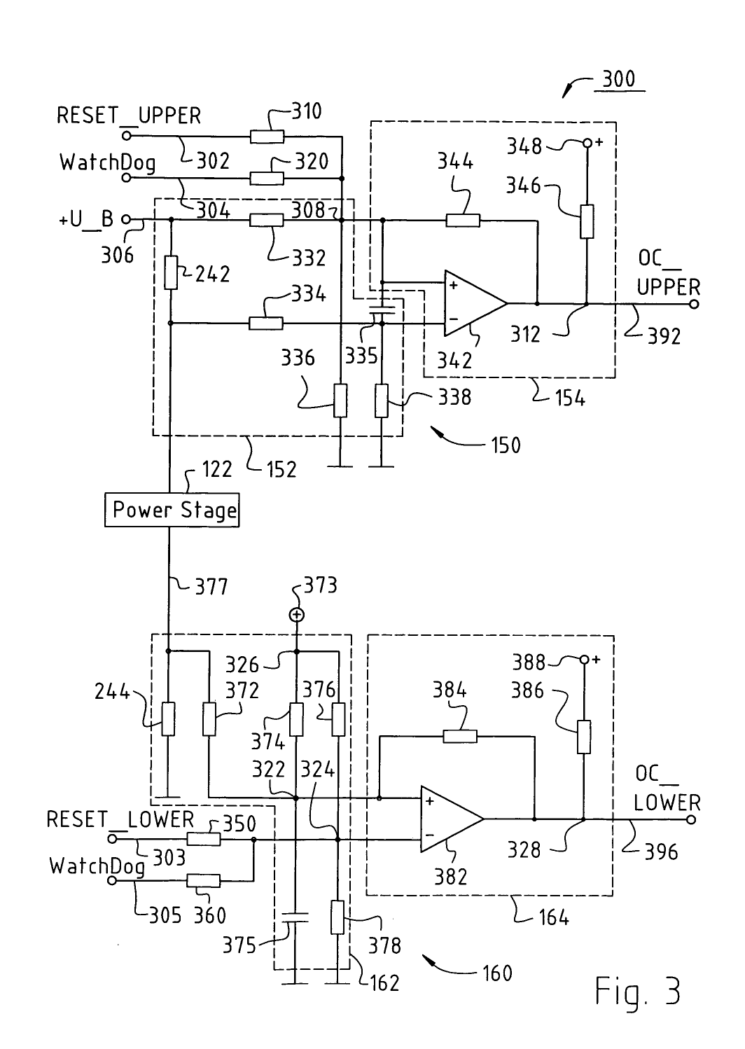

Analogously, because of the arrangement of overcurrent controller 160 on the “lower side” of power stage 122, overcurrent measuring element 162 can preferably be implemented for detecting an overcurrent that occurs as a consequence of a short circuit to ground (cf. FIG. 2). Both overcurrent measuring element 152 and overcurrent measuring element 162 can, however, be implemented to detect overcurrents that occur as a consequence of a short circuit of one or more semiconductor switches of power stage 122. Upon occurrence of an overcurrent as a consequence of a short circuit of one or more of the semiconductor switches of power stage 122, for example, both overcurrent measuring elements 152, 162 would therefore detect that overcurrent, whereas an overcurrent that occurs as a consequence of a short circuit to the positive supply lead will be detected only by overcurrent measuring element 152, and an overcurrent occurring as a consequence of a short circuit to ground will be detected only by overcurrent measuring element 162. Suitable exemplifying embodiments of corresponding overcurrent measuring elements are described in further detail below with reference to FIG. 3.

In response to the detection of an overcurrent by at least one of overcurrent measuring elements 152, 162, overcurrent measuring element 152 or 162 that detects the overcurrent delivers, to the associated holding element, a signal characterizing the overcurrent. Accordingly, overcurrent measuring element 152 delivers a corresponding signal to holding element 154, and/or overcurrent measuring element 162 delivers a corresponding signal to holding element 164. In reaction to that signal, holding element 154 and/or holding element 164 generates an overcurrent signal and holds it, regardless of further changes over time in the received signal. Holding element 154 generates the overcurrent signal OC_UPPER, and holding element 164 generates the overcurrent signal OC_LOWER.

Each of the overcurrent signals OC_UPPER and OC_LOWER is delivered to controller 130, which is configured to influence, in reaction to reception of at least one of overcurrent signals OC_UPPER or OC_LOWER, the commutation signals for power stage 122 of ECM 120 that are made available by commutation controller 132.

This influence preferably serves to switch off ECM 120 by means of a shutoff of power stage 122, in order to prevent any damage to ECM 120 or to power stage 122 by the overcurrent. For that purpose, commutation controller 132 influences the commutation signals that it furnishes, in accordance with a preferred embodiment of the invention, in such a way that all the semiconductor switches of power stage 122 are switched off, so that current can no longer flow into the at least one stator phase of ECM 120, and ECM 120 is thus switched off. The manner in which apparatus 100 functions to shut off power stage 122 is described in further detail below, with reference to FIG. 2.

According a preferred embodiment of the invention, after a predetermined period of time controller 130 outputs the reset signals RESET_UPPER and RESET_LOWER to overcurrent controllers 150 and 160 in order to reset holding elements 154 and 164. A reset of holding elements 154 and 164 causes a new evaluation of the input signal (characterizing the overcurrent) of these holding elements, in order to determine whether the short circuit still exists. In the case in which the signal characterizing the overcurrent is still present at its input, holding element 154 and/or 164 once again generates the overcurrent signal OC_UPPER or OC_LOWER and delivers it to controller 130. In the case in which the signal characterizing the overcurrent is no longer present at the input of holding element 154 and/or at the input of holding element 164, another new overcurrent signal is not generated, and ECM 120 can return to its normal operation.

Be it noted that the reset signals RESET_UPPER and RESET_LOWER can also be outputted selectively. For example, if only holding element 164 outputs an overcurrent signal, i.e. the overcurrent signal OC_LOWER, or if only overcurrent controller 160 is being used, it is sufficient to output the reset signal RESET_LOWER to overcurrent controller 160. For simplicity's sake, however, it is also possible for the corresponding reset signal to be outputted to both overcurrent controllers.

In addition, the reset signals can be outputted not only after the predetermined period of time, but also in response to an explicit instruction from controller 130. For example, a user can actuate a reset button (not depicted), provided for that purpose, in order to instruct controller 130 to bring about a reset of holding element 154 and/or of holding element 164.

FIG. 2 is a simplified circuit diagram of a preferred circuit 200 with which apparatus 100 for operating ECM 120, having a short-circuit shutoff system of FIG. 1 is implemented according to a first embodiment. The exemplifying circuit 200 accordingly encompasses a plurality of components that constitute rotor/stator arrangement 124 and power stage 122 of ECM 120, the at least one rotor position sensor 140, controller 130, voltage measuring element 110, and overcurrent controllers 150 and 160.

Rotor/stator arrangement 124 of ECM 120 is depicted here schematically with a rotor 208 and a stator 201. Rotor 208 is depicted, by way of example, as a permanent-magnet rotor having four magnet poles. Alternatively, rotor 208 can be excited by the delivery of current, so that permanent magnets can be dispensed with. Stator 201 is depicted, by way of example, as having three phases, with three stator phases 202, 204, and 206 that are connected in delta fashion as shown in FIG. 2. A wye-configured circuit, separate control of each stator phase, or even a different number of phases, would also be possible. Associated with each of stator phases 202, 204, and 206 is a respective terminal U, V, and W through which the stator phases are connected to power stage 122.

Each of MOSFETs 212, 214, 216, 222, 224, 226 of power stage 122 is connected to a commutation controller 280 (COMMUT_CTL) that is connected, at the input side, to a commutation signal generator 234 (COMMUT). According to a preferred embodiment of the invention, commutation controller 280 and commutation signal generator 234 together constitute commutation controller 132 of controller 130 of FIG. 1.

Terminal U of stator phase 202 is connected to +U_B via upper semiconductor switch 212 (S1) and upper measuring resistor 242. It is connected to ground (GND) via lower semiconductor switch 222 (S2) of power stage 122 and measuring resistor 244. Terminal V of stator phase 204 is analogously connected, via upper semiconductor switch 214 (S3) and lower semiconductor switch 224 (S4) of power stage 122, respectively to +U_B and to GND. Terminal W of stator phase 206 is analogously connected, via upper semiconductor switch 216 (S5) and lower semiconductor switch 226 (S6) of power stage 122, respectively to +U B and to GND.

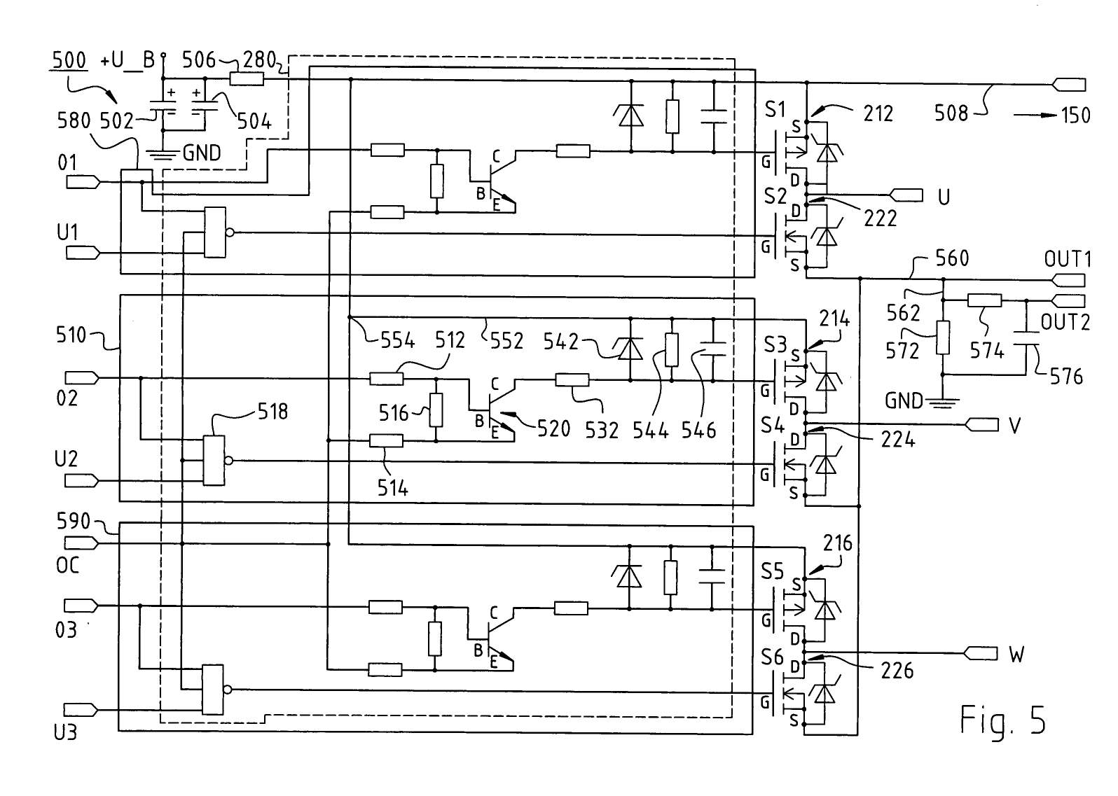

According to a preferred embodiment of the present invention, upper and lower semiconductor switches 212, 214, 216, 222, 224, and 226 are realized using field-effect transistors of the MOSFET or IGBT (Insulated Gate Bipolar Transistor) type, which comprise integrated free-wheeling diodes (cf. FIG. 5) whose conducting-state voltage is generally between 0.7 and 1.4 V. Such components are available from Infineon and other semiconductor manufacturers. In FIG. 2, upper semiconductor switches 212, 214, and 216 are configured as P-channel MOSFETs, and lower semiconductor switches 222, 224, and 226 as N-channel MOSFETs, terminals U, V, and W being respectively connected to drain terminals D of the associated upper and lower MOSFETs. Gate terminals G of the upper and lower MOSFETs are connected to commutation controller 280. Each gate terminal G of lower MOSFETs 222, 224, and 226 is likewise connected to commutation controller 280. Commutation controller 280 is described in further detail below, by way of example, with reference to FIG. 5.

Source terminals S of upper MOSFETs 212, 214, and 216 are connected to one another via a node 211 on the “upper side” of power stage 122. Node 211 is connected to +U_B via a resistor 242 that is hereinafter referred to as an “upper measuring resistor.” In FIG. 2, upper measuring resistor 242 is connected, for example, to +U_B via supply lead 246.

Source terminals S of lower MOSFETs 222, 224, and 226 are connected to one another via a node 221 on the “lower side” of power stage 122. Node 221 is connected to ground GND via a measuring resistor 244 hereinafter referred to as a “lower measuring resistor.” In FIG. 2, lower measuring resistor 244 is connected, for example, to ground GND via a lead 248 referred to hereinafter as a “return lead.”

Node 221 and return lead 248 are connected to an input side of overcurrent controller 160. The output side of overcurrent controller 160 is connected on the one hand to commutation controller 280, and on the other hand to an overcurrent detection unit 292 (OVERCURRENT_LOWER) and to a reset element 290 (RESET_LOWER). Be it noted, however, that overcurrent detection unit 292 is depicted as part of reset element 290 only by way of example, and can also be implemented independently of it. Reset element 290 is fed back at the output side to overcurrent controller 160, and overcurrent detection unit 292 is connected at the output side to commutation signal generator 234 of controller 130.

Node 211 and supply lead 246 are connected to an input side of overcurrent controller 150. The output side of overcurrent controller 150 is connected on the one hand to commutation controller 280, and on the other hand to an overcurrent detection unit 272 (OVERCURRENT_UPPER) and to a reset element 270 (RESET_UPPER). Be it noted, however, that overcurrent detection unit 272 is depicted as part of reset element 270 only by way of example, and can also be implemented independently of it. Reset element 270 feeds back at the output side to overcurrent controller 150, and overcurrent detection unit 272 is connected at the output side to commutation signal generator 234 of controller 130.

Supply lead 246 is furthermore connected to voltage measuring element 110, which is depicted by way of example as an A/D converter. As depicted in FIG. 2, this can be an element of controller 130, which moreover comprises an input/output device 235 (I/O) for outputting an ERROR signal. Controller 130 (cf. FIG. 1) is usefully implemented as a microcontroller.

Controller 130 is connected via an input device 236 (Rotor Position) to rotor position sensor 140 which is constituted, for example, by three Hall sensors 252, 254, and 256.

As is apparent from FIG. 2, Hall sensor 252 is connected to an input H1 of input device 236. Hall sensor 254 is connected to an input H2 and is arranged at an offset of 120° el. from Hall sensor 252. Hall sensor 256 is connected to an input H3 and is arranged at an offset of 120° el. from Hall sensor 254, and 240° el. from Hall sensor 252. Input device 236 is connected on the one hand to commutation signal generator 234 and on the other hand to a rotation speed controller 238 (N-CTL). Rotation speed controller 238 is in turn likewise connected to commutation signal generator 234, and controls the latter's signals.

Mode of Operation

When apparatus 200 is in operation, supply voltage U_B is applied to power stage 122 in order to energize stator 201. Supp-y voltage U_B is preferably a substantially constant DC voltage that is generated by a power supply or a battery and is converted, by the use of stator phases 202, 204, and 206, into rotation of rotor 208. The Hall signals resulting in this context are delivered via Hall sensors 252, 254, and 256 to rotation speed controller 238, which determines from the Hall signals an actual rotation speed value of rotor 208. Using the actual rotation speed value, rotation speed controller 238 generates a rotation speed controlled variable that is delivered to commutation signal generator 234.

As a function of the rotation speed controlled variable and the Hall signals H1, H2, H3, commutation signal generator 234 generates commutation signals for controlling power stage 122, which are delivered via commutation controller 280 to gate terminals G of the upper and lower MOSFETs. The commutation signals can have corresponding Pulse Width Modulation (PWM) signals superimposed on them in order to control the MOSFETs, so that, with the use of these MOSFETs, the currents flowing through stator phases 202, 204, and 206 are controlled so as to generate a rotating magnetic field in order to drive rotor 208. For commutation of the motor currents, the upper and lower MOSFETs are switched on and off by the commutation signals in order to control the currents in stator phases 202, 204, and 206 as known to one skilled in the art.

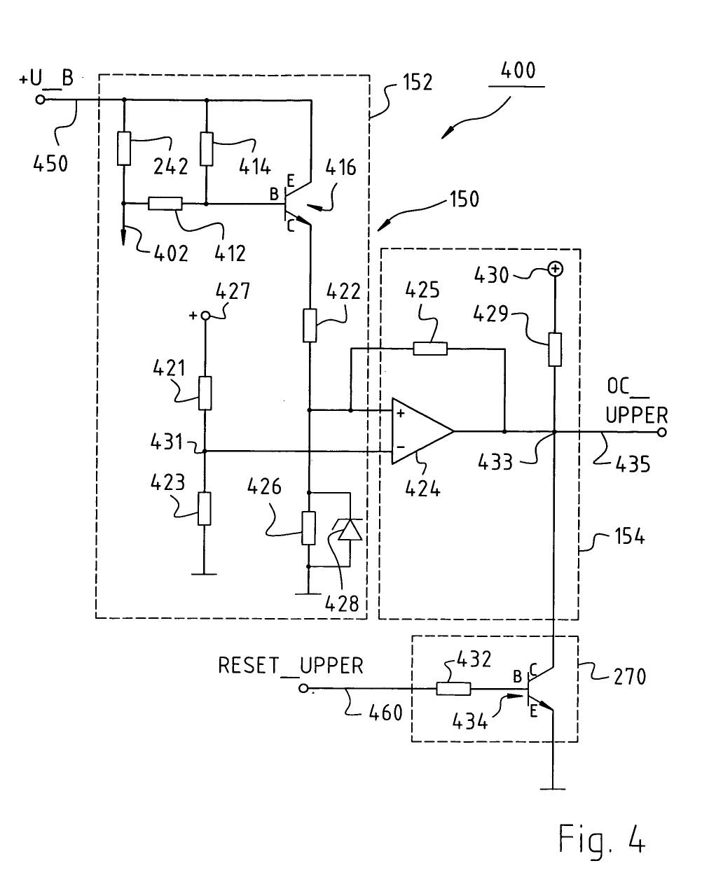

When apparatus 200 is in operation, the voltage drop at upper measuring resistor 242 is measured with overcurrent controller 150 in order to allow detection of an overcurrent occurring on the “upper side” of power stage 122, as described in detail below with reference to FIGS. 3 and 4. The voltage drop across upper measuring resistor 242 characterizes the actual current value I UPPER at node 211, and is compared with a maximum current value I_MAX_UPPER permissible at node 211. In the event the actual current value at node 211 exceeds the maximum current value permissible at node 211, this means that an overcurrent is occurring at node 211.

If overcurrent controller 150 detects an overcurrent at node 211, said controller generates an overcurrent signal OC_UPPER (cf. FIG. 1) and outputs it to overcurrent detection unit 272 and to commutation controller 280.

Overcurrent controller 160 measures the voltage drop at lower measuring resistor 244 in order to allow detection of an overcurrent occurring on the “lower side” of power stage 122, as described in detail below with reference to FIG. 3. The voltage drop across lower measuring resistor 244 characterizes the actual current value I_LOWER at node 221, and is compared with a maximum current value I_MAX_LOWER permissible at node 221. In the event the actual current value at node 221 exceeds the maximum current value permissible at node 221, this means that an overcurrent is occurring there. If overcurrent controller 160 detects an overcurrent at node 221, said controller generates an overcurrent signal OC_LOWER (cf. FIG. 1) and outputs it to overcurrent detection unit 292 and to commutation controller 280.

Upon reception of the overcurrent signal OC_UPPER by overcurrent detection unit 272, reset element 270 is initialized. A timing system can be started in order to determine when a predetermined time period has elapsed, after which reset element 270 outputs a corresponding reset signal RESET_UPPER to overcurrent controller 150 for resetting.

Reset element 290 is initialized upon reception of the overcurrent signal OC_LOWER by overcurrent detection unit 292; once again a timing system can be started in order to determine when the predetermined time period has elapsed, after which reset element 290 outputs a corresponding reset signal RESET_LOWER to overcurrent controller 160 in order to reset it.

As an alternative to this, an initialization of reset element 270 and/or of reset element 290 can be accomplished by means of an external instruction, for example actuation of a reset button by a user, via controller 130. For this, in the event an overcurrent is detected, the ERROR signal is outputted via input/output device 235. In reaction to the output of the ERROR signal, the user can perform corresponding suitable actions for error analysis and in order to correct the short circuit.

According to a preferred embodiment, upon reception of the overcurrent signal OC_UPPER and/or the overcurrent signal OC_LOWER, commutation controller 280 influences the commutation signals generated by commutation signal generator 234 in such a way that power stage 122 is switched off, so that stator 201 transitions into the currentness state. The commutation signals are preferably set by commutation controller 280 in such a way that all the upper and lower MOSFETs 212, 214, 216, 222, 224, and 226 are made non-conductive, so that power stage 122 is shut off. Because current can therefore no longer flow into stator phases 202, 204, and 206, the motor current in stator 201 decays and it transitions into the currentness state.

As a result of the shutoff of power stage 122 and therefore of ECM 210, power stage 122 and the motor are protected from damage or destruction due to the overcurrent that has occurred.

As described below in detail with reference to FIG. 3, the overcurrent signal OC_UPPER and/or the overcurrent signal OC_LOWER are preferably maintained or saved independently of the presence of a corresponding overcurrent at power stage 122, so that ECM 120 cannot transition back to normal operation.

In order to enable a transition to normal operation, overcurrent controller 150 and/or overcurrent controller 160 must be reset by the reset signal RESET_UPPER or RESET_LOWER. This is accomplished either after the predetermined time period has elapsed, or in reaction to a corresponding instruction by controller 130 (cf. FIG. 1). If resetting takes place even through the overcurrent still exists, an overcurrent signal OC_UPPER and/or OC_LOWER is once again generated by overcurrent controller 150 or 160, and power stage 122 remains shut off. If an overcurrent no longer exists, however, power stage 122 is once again commutated normally, and ECM 120 transitions to normal operation.

FIG. 3 is a simplified circuit diagram of an apparatus 300 for detecting an overcurrent at a power stage and for generating overcurrent signals to shut off the power stage. As indicated in FIG. 3, this power stage corresponds, by way of example, to power stage 122 of FIGS. 1 and 2, which is connected on its “upper side” to measuring resistor 242 that is connected to overcurrent controller 150. On its “lower side,” power stage 122 is connected to measuring resistor 244 that is connected to overcurrent controller 160. According to FIG. 1 overcurrent controller 150 comprises overcurrent measuring element 152 and holding element 154, and according to FIG. 1 overcurrent controller 160 comprises overcurrent measuring element 162 and holding element 164. Exemplifying circuits for realizing overcurrent controllers 150, 160 are described below in detail.

The exemplifying circuit for implementing overcurrent controller 150 comprises three input leads 302, 304, 306. Lead 302 is connected via a resistor 310 to a node 308. Lead 304 is likewise connected to node 308 via a resistor 320. Lead 306 is connected on the one hand via measuring resistor 242 to the “upper side” of power stage 122, and on the other hand via a resistor 332 to node 308. Node 308 is connected on the one hand via a resistor 336 to ground, and on the other hand to the non-inverting input (+) of a differential amplifier 342. The inverting input (−) of differential amplifier 342 is connected on the one hand via a resistor 334 to the “upper side” of power stage 122, and on the other hand via a resistor 338 to ground.

The inverting input (−) of differential amplifier 342 is furthermore connected via a capacitor 335 to its non-inverting input (+). According to a preferred embodiment, capacitor 335 and resistors 242, 332, 334, 336, and 338 constitute overcurrent measuring element 152.

The output of differential amplifier 342 is connected on the one hand to a node 312 and to a lead 392, and on the other hand fed back via a resistor 344 to its non-inverting input (+). Node 312 is connected via a resistor 346 to a reference voltage source 348. Differential amplifier 342, resistors 344, 346, and reference voltage source 348 constitute holding element 154.

The exemplifying circuit for implementing overcurrent controller 160 comprises two leads 303, 305 at the input side. Lead 303 is connected via a resistor 350 to a node 324. Lead 305 is likewise connected to node 324 via a resistor 360. Node 324 is connected on the one hand to the inverting input (−) of a differential amplifier 382, and on the other hand via a resistor 378 to ground. Node 324 is furthermore connected via a resistor 376 to a node 326. Node 326 is connected on the one hand to a reference voltage source 373, and on the other hand via a resistor 374 to a node 322 that is connected to the non-inverting input (+) of differential amplifier 382. Node 322 is furthermore connected via a capacitor 375 to ground, and via a resistor 372 to a lead 377 that connects the “lower side” of power stage 122 to measuring resistor 244. According to a preferred embodiment, capacitor 375 and resistors 244, 372, 374, 376, and 378 constitute overcurrent measuring element 162.

The output of differential amplifier 382 is connected on the one hand to a node 328 and to a lead 396, and on the other hand fed back via a resistor 384 to its non-inverting input (+). Node 328 is connected via a resistor 386 to a reference voltage source 388. Differential amplifier 382, resistors 384, 386, and reference voltage source 388 constitute holding element 164.

All the reference voltage sources 348, 373, 388 preferably generate a DC voltage signal having an amplitude of +5 V. All the reference voltage sources 348, 373, 388 can accordingly be implemented by means of a single appropriate constant-voltage source.

When apparatus 300 is in operation, a voltage drop across measuring resistor 242 is picked off and is delivered, via a first voltage divider constituted by resistors 334 and 338, to the inverting input (−) of differential amplifier 342. In addition, supply voltage +U_B, which is smoothed by capacitor 335, is delivered, via lead 306 and a second voltage divider constituted by resistors 332 and 336, to the non-inverting input (+) of differential amplifier 342.

The first and the second voltage divider are implemented in such a way that the potential at the inverting input (−) of differential amplifier 342 during normal operation is greater than the potential at its non-inverting input (+), so that the output of differential amplifier 342 is low-resistance during normal operation. If an overcurrent then occurs at measuring resistor 242, the potential at the non-inverting input (+) is increased by the second voltage divider, so that the potential at the non-inverting input (+) of differential amplifier 342 becomes greater than the potential at the inverting input (−). As a result, the output of differential amplifier 342 is switched to TRISTATE and thus becomes high-resistance, thereby generating an overcurrent signal OC_UPPER that is outputted via lead 392.

The overcurrent signal OC_UPPER is preferably fed back via resistor 344 to the non-inverting input (+) of differential amplifier 342. To enable self-holding of the overcurrent signal OC_UPPER by differential amplifier 342, the potential at its non-inverting input (+) must remain greater than the potential at its inverting input (−). The fed-back overcurrent signal OC_UPPER is therefore combined with a reference voltage signal made available by reference voltage source 348 via resistor 346. This reference voltage signal is configured so that it alone is not sufficient to cause generation of the overcurrent signal OC_UPPER by differential amplifier 342, but is sufficient only in combination with the overcurrent signal OC_UPPER. The result is that differential amplifier 342 generates the overcurrent signal OC UPPER only when an overcurrent is measured at measuring resistor 242.

Self-holding by holding element 154 by means of storage of the overcurrent signal OC_UPPER makes it possible to maintain the currentless state of power stage 122 and of the associated ECM, i.e. ECM 120 of FIG. 2, for at least a predetermined period of time. It is thus possible to prevent power stage 122 from once again commutating ECM 120 normally, and ECM 120 from transitioning to normal operation, due to a cancellation of the overcurrent signal OC_UPPER while a short circuit continues to exist during the predetermined time period; this could result in damage to or destruction of power stage 122 or ECM 120.

The supply voltage +U_B can be combined via lead 304 with a so-called watchdog signal that serves to signal the operational readiness of controller 130 according to FIGS. 1 and 2. The level of the watchdog signal is preferably HIGH when controller 130 is not operationally ready. For the instance in which controller 130 is not operationally ready, it is thus possible according to the present invention, by combining supply voltage +U_B with the watchdog signal, to generate at the non-inverting input (+) of differential amplifier 342 a potential which is sufficiently high to cause generation of the overcurrent signal OC_UPPER. For the instance in which controller 130 is operationally ready, the watchdog signal is preferably LOW and therefore has no influence on generation of the overcurrent signal OC_UPPER.

The supply voltage +U_B can be combined via lead 302 with a reset signal RESET_UPPER that serves to reset holding element 154. The potential at the non-inverting input (+) of differential amplifier 342 must accordingly be lowered by the reset signal RESET_UPPER in such a way that the potential at its inverting input (−) becomes greater in comparison therewith, and the output of differential amplifier 342 thus switches back to low-resistance. For that purpose, the potential at the non-inverting input (+) of differential amplifier 342 can, for example, be pulled to ground by the reset signal RESET UPPER. A similar effect can be achieved by the watchdog signal.

A resetting of holding element 154 automatically causes a new evaluation, with which a determination is made as to whether the detected overcurrent, and therefore the short circuit underlying it, still exists. If the short circuit still exists, the overcurrent signal OC_UPPER is once again generated so that power stage 122 remains shut off. In the event the short circuit no longer exists, the overcurrent signal OC_UPPER is not generated again, and ECM 120 can return to its normal operation with no need for any further checking of ECM 120.

Analogously thereto, a voltage drop across measuring resistor 244 is picked off and is combined via resistor 372 with a reference voltage signal generated by reference voltage source 373. The combined signal is smoothed by capacitor 375 and delivered to the non-inverting input (+) of differential amplifier 382. The reference voltage signal made available by reference voltage source 373 is delivered to the inverting input (−) of differential amplifier 382 via a voltage divider constituted by resistors 376 and 378. A substantially constant potential is generated in this context at the inverting input (−) of differential amplifier 382; in normal operation, that potential is greater than the potential at its non-inverting input (+), so that in normal operation the output of differential amplifier 382 is low-resistance.

If an overcurrent then occurs at measuring resistor 244, the potential at the non-inverting input (+) is increased by resistor 372 in such a way that the potential at the non-inverting (+) input of differential amplifier 382 becomes greater than the potential at the inverting input (−). As a result, the output of differential amplifier 382 is switched to TRISTATE and thus becomes high-resistance, thereby generating an overcurrent signal OC_LOWER that is outputted via lead 396.

For signal generation and for self-holding, differential amplifier 382 is operated analogously to differential amplifier 342, i.e. with a feedback signal, fed back via resistor 384, that is combined with a reference voltage signal made available by reference voltage source 388 via a resistor 386. Overcurrent controller 160 can furthermore also be reset using a corresponding reset signal, i.e. the reset signal RESET LOWER; and by analogy with what is described above, a watchdog signal can also be used in the context of overcurrent controller 160. Because overcurrent controller 160 processes these signals similarly to overcurrent controller 150, a detailed description will be dispensed with at this point.

Both overcurrent controllers 150, 160 make possible the detection of overcurrents that occur in the event of short circuits in the motor winding and in the bridge transistors (i.e. MOSFETs 212, 214, 216, 222, 224, and 226 of FIG. 2) of power stage 122. Overcurrent controller 150 is moreover preferably implemented for detecting overcurrents that occur as a result of short circuits with lead 306 for the delivery of supply voltage U_B. Overcurrent controller 160 is preferably configured for detecting overcurrents that occur as a result of short circuits to ground.

Examples of values for individual components of the exemplifying circuits for implementing overcurrent controllers 150, 160 according to a preferred embodiment are indicated below:

| | | |
|---|---|---|
| Resistors 310, 336, 338 | 1 | kilohm |
| Resistor 332 | 8.2 | kilohm |
| Resistor 334 | 9.1 | kilohm |
| Resistor 344 | 2.2 | kilohm |
| Resistors 346, 350, 372, 374, 376, 378, 384, 386 | 4.7 | kilohm |
| Capacitors 335, 375 | 1 | nF |
| Capacitor 375 | 1 | nF |

FIG. 4 is a simplified circuit diagram of an apparatus 400 for detecting an overcurrent on an “upper side” of a power stage, for example power stage 122 of FIGS. 1 and 2, and for generating an overcurrent signal to shut off the power stage, according to a further preferred embodiment. As indicated in FIG. 4, apparatus 400 implements, by way of example, overcurrent controller 150 having overcurrent measuring element 152 and holding element 154 according to FIGS. 1 and 2, as well as reset element 270 according to FIG. 2.

Apparatus 400 has at the input side a lead 450 that is connected on the one hand via measuring resistor 242 to the “upper side” of power stage 122 (not depicted) as indicated by an arrow 402, and on the other hand to the emitter terminal of a PNP transistor 416. The “upper side” of power stage 122 (not depicted) is furthermore connected via a resistor 412 to the base terminal of transistor 416. The base terminal of transistor 416 is furthermore connected via a resistor 414 to its emitter. The collector of transistor 416 is connected via a resistor 422 to the non-inverting input (+) of a differential amplifier 424 that is connected to ground via a parallel circuit made up of a resistor 426 and a Zener diode 428, the anode side of Zener diode 248 being connected to ground. The inverting input (−) of differential amplifier 424 is connected to a node 431 that is connected on the one hand via a resistor 421 to a reference voltage source 427, and on the other hand via a resistor 423 to ground. Resistors 242, 412, 414, 421, 422, 423, 426, reference voltage source 427, transistor 416, and Zener diode 428 implement overcurrent measuring element 152.

The output of differential amplifier 424 is connected on the one hand to a node 433 in a lead 435, and on the other hand is fed back via a resistor 425 to its non-inverting input (+). Node 433 is connected via resistor 429 to a reference voltage source 430. According to a preferred embodiment, differential amplifier 424, resistors 425, 429, and reference voltage source 430 constitute holding element 154.

Node 433 is furthermore connected to the collector of an NPN transistor 434 whose emitter is connected to ground. The base terminal of transistor 434 is connected via a resistor 432 to a lead 460. Transistor 434 and resistor 432 constitute reset element 270.

When apparatus 400 is in operation, a voltage drop across measuring resistor 242 is picked off and is delivered via resistor 412 to the base of transistor 416. Upon the occurrence of an overcurrent, transistor 416 is made conductive, so that the potential at non-inverting input (+) of differential amplifier 424 can be increased by way of a voltage divider constituted by resistors 422 and 426. A substantially constant limit-value voltage, formed by reference voltage source 427 and a second voltage divider constituted by resistors 421 and 423, is present at the inverting input (−) of differential amplifier 424. The output of differential amplifier 424 is thereby switched to TRISTATE, since upon occurrence of an overcurrent, the potential at the non-inverting input (+) of differential amplifier 424 becomes greater than the potential at its inverting input (−) and thus becomes high-resistance, with the result that an overcurrent signal OC_UPPER is generated and is outputted from holding element 154 via lead 435.

The manner of operation of holding element 154 of FIG. 4, i.e. of differential amplifier 424, feedback resistor 425, resistor 429, and reference voltage source 430, corresponds to the manner of operation of the corresponding elements of holding element 154 described with reference to FIG. 3, and is therefore not described here in detail.

According to FIG. 4, the reset signal RESET UPPER is delivered via lead 460 and resistor 432 to the base of transistor 434. Transistor 434 is made conductive by this reset signal RESET_UPPER, so that node 433 is pulled to ground. The non-inverting input (+) of differential amplifier 424 is thus likewise pulled to ground, thereby resetting holding element 154 and overcurrent controller 150.

The use of bipolar transistors 416 and 434 allows a precise detection of overcurrents; detection can be further improved, with reference to the circuit described in FIG. 3, because of the circuit properties of those transistors. Transistors 416 and 434 furthermore permit a reduction in the reaction times of overcurrent controller 150 and reset element 270.

The circuit according to FIG. 4 is advantageous as compared with the circuit according to FIG. 3 because, as a result of the use of transistor 416, it is influenced very little by variations or tolerances in the resistors occurring during manufacture.

FIG. 5 is a simplified circuit diagram of an exemplifying apparatus 500 for controlling upper and lower bridge transistors of a power stage, e.g. MOSFETs 212, 214, 216, 222, 224, 226 of power stage 122 of FIGS. 1 to 3, which are depicted by way of example with their integrated free-wheeling diodes.

Apparatus 500 is moreover configured for processing an overcurrent signal OC, which can be both an overcurrent signal OC_UPPER according to FIGS. 1 to 4 and an overcurrent signal OC_LOWER according to FIGS. 1 to 3, and which for simplicity's sake is therefore labeled in FIG. 5 simply as the overcurrent signal OC.

The exemplifying apparatus 500 has at the input side a supply voltage source +U_B that is connected on the one hand to ground GND via a parallel circuit made up of two link circuit capacitors 502, 504, and on the other hand to a lead 508 via a resistor 506. Lead 508 is connected, by way of example, to three signal conditioning devices 510, 580, 590, and serves at the output side for the connection of overcurrent controller 150 of FIGS. 1 to 4.

The three signal conditioning devices 510, 580, 590 implement commutation controller 280 of FIG. 2 and serve to condition corresponding commutation signals generated by commutation signal generator 234 of FIG. 2 in reaction to the overcurrent signal OC. Signal conditioning device 580 serves to condition the commutation signals O1 and U1 for the associated MOSFETs 212, 222 that are connected to terminal U (FIG. 2) of stator arrangement 201. Signal conditioning device 510 serves to condition the commutation signals O2 and U2 for the associated MOSFETs 214, 224 that are connected to terminal V of stator 201. Signal conditioning device 590 serves to condition the commutation signals O3 and U3 for the associated MOSFETs 216, 226 that are connected to terminal W of stator 201. As is evident from FIG. 5, signal conditioning devices 510, 580, 590 are identical in configuration, so that for simplification, only the configuration of device 510 will be explained in more detail.

Signal conditioning device 510 comprises a lead 552 that is connected at the input side via a node 554 to lead 508, and at the output side to source terminal S of the upper bridge transistor, i.e. of MOSFET 214. Lead 552 is additionally connected to gate terminal G of MOSFET 214 via a parallel circuit made up of a resistor 544, a capacitor 546, and a Zener diode 542 whose cathode end is connected to lead 552.

Gate terminal G of MOSFET 214 is connected via a resistor 532 to collector C of an NPN transistor 520. Base B of transistor 520 is connected on the one hand via a resistor 516 to its emitter E, and on the other hand via a resistor 512 to a terminal for the commutation signal O2. Emitter E of transistor 520 is furthermore connected via a resistor 514 to a terminal for the overcurrent signal OC. The terminal for the commutation signal O2 is furthermore connected to an IC 518 that is connected at the input side to a terminal for the commutation signal U2 and to the terminal for the overcurrent signal OC. At the output side, IC 518 is connected to gate G of the lower bridge transistor, i.e. of MOSFET 224.

Drain terminals D of MOSFETs 214, 224 are connected to winding terminal V. Source S of MOSFET 224 is connected to a lead 560 that is connected on the one hand to a terminal OUT1 and on the other hand to a lead 562. Lead 562 is connected on the one hand via a measuring resistor 572 to ground GND (Shunt), and on the other hand via a resistor 574 to a terminal OUT2. Terminal OUT2 is likewise connected to ground GND via a capacitor 576. The signal generated at terminal OUT2 corresponds substantially to the voltage drop at resistor 572, and thus indicates the current flowing through the power stage. Terminal OUT2 is connected to controller 130 (not depicted in this Figure) of FIGS. 1 and 2, the signals produced at this terminal being used upon generation of the commutation signals.

When apparatus 500 is in operation, the overcurrent signal OC is generated upon occurrence of an overcurrent caused by a short circuit, and is delivered to signal conditioning devices 510, 580, 590. In signal conditioning device 510, transistor 520 is made non-conductive in reaction to the overcurrent signal OC, since the overcurrent signal OC causes emitter terminal E of transistor 520 to be set to HIGH. The potential at the gate terminal of the upper bridge transistor, i.e. of MOSFET 214, is thereby reduced, so that MOSFET 214 is likewise made non-conductive.

IC 518 is configured in such a way that, in reaction to the overcurrent signal OC, it acts on gate terminal G of the lower bridge transistor, i.e. of MOSFET 224, in such a way that MOSFET 224 is also made non-conductive.

Analogously thereto, the other bridge transistors, i.e. MOSFETs 212, 222, 216, 226, are also made non-conductive in reaction to the reception of the overcurrent signal OC, so that power stage 122 is shut off and ECM 120 (not shown) transitions into the currentness state. By means of the shutoff of power stage 122, the power stage and the ECM can thus advantageously be protected from damage or destruction as a result of the overcurrent occurring because of the short circuit.

Many variants and modifications are of course possible within the scope of the present invention.

What is claimed is:

1. An electronically commutated motor (ECM) comprising:
a rotor (208);
a stator (201) for electromagnetically interacting with the rotor (208), which stator is equipped with a stator winding arrangement (202, 204, 206);
a power stage (122) for controlling the currents flowing in the stator winding arrangement (202, 204, 206) during operation;
at least one current measuring element (242, 244) for sensing a measured value for the currents (I UPPER, I LOWER) flowing in the power stage;
an overcurrent measuring element (152, 162) for evaluating an associated measured value and for sensing a current whose absolute value exceeds a predetermined limit value (I_MAX_UPPER, I_MAX_LOWER); and
a holding element (154, 164) associated with the overcurrent measuring element (152, 162), which holding element is configured, upon occurrence of an overcurrent in the associated current measuring element (242, 244), to generate an overcurrent signal (OC_UPPER, OC_LOWER), to store it, and to deliver to the power stage (122) a corresponding signal in order to counteract the overcurrent.

2. The motor according to claim 1, wherein
a holding element (154, 164) is configured to store the overcurrent signal upon its occurrence.

3. The motor according to claim 1, wherein
a holding element (154, 164) is configured to store the overcurrent signal, upon its occurrence, for a predetermined time period.

4. The motor according to claim 1, further comprising
a reset element (270, 290) adapted to reset the holding element (154, 164).

5. The motor according to claim 4, wherein
the reset element (270, 290) is configured to reset the holding element (154, 164) after a predetermined time period.

6. The motor according to claim 4, wherein
the reset element (270, 290) is configured to reset the holding element (154, 164) in response to an external activation of the reset element.

7. The motor according to claim 1, further comprising
a control circuit (280) controlled by the holding element (154, 164), which circuit is configured to switch off the power stage (122) in the event of an overcurrent, in order to prevent damage to the motor, including its electronics, by the detected overcurrent.

8. The motor according to claim 1, wherein
the holding element comprises a differential amplifier (342, 382, 424) that has an input and an output and is configured to compare a signal derived from the current in the current measuring element (242, 244) with a maximum value, and to generate an overcurrent signal (OC_UPPER, OC_LOWER) when the current-derived signal exceeds the maximum value.

9. The motor according to claim 8, wherein
the output of the differential amplifier (342, 382, 424) is fed back to its non-inverting input (−) in order to bring about self-holding, by way of the feedback, upon generation of an overcurrent signal at the output of the differential amplifier.

10. The motor according to claim 1, wherein
the current measuring element (242, 244) is implemented as a measuring resistor.

11. The motor according to claim 1, wherein
the current measuring element (242, 244) is arranged between a supply voltage source (+U_B, GND) and the power stage (122) in order to sense a signal describing the power-stage current.

12. The motor according to claim 1, wherein
the power stage (122) comprises at least one semiconductor switch that can be switched off, at least for a time interval, upon occurrence of an overcurrent signal.

13. The motor according to claim 1, wherein
said stator winding arrangement has at least one stator phase (202, 204, 206);
the power stage has, for stator phase control, a full bridge having upper and lower semiconductor switches (212, 214, 216, 222, 224, 226), and
the control circuit (280) is configured to render all the upper and lower semiconductor switches non-conductive, in order to switch off the power stage.

14. The motor according to claim 13, wherein
at least one first overcurrent measuring element (162) is connected to a first measuring resistor (244), arranged between ground and the lower semiconductor switches (222, 224, 226) of the power stage, in order to sense a first signal describing the power-stage current; and
at least one second overcurrent measuring element (152) is connected to a second measuring resistor (242), arranged between a supply voltage source (+U_B) and the upper semiconductor switches (222, 224, 226) of the power stage, to sense a second signal describing the power-stage current.

15. The motor according to claim 14, wherein
the first overcurrent measuring element (162) has associated therewith a first holding element (164) which is configured to generate a first overcurrent signal (OC_LOWER) when an overcurrent is detected at the first measuring resistor (244); and
the second overcurrent measuring element (152) has associated therewith a second holding element (154) which is configured to generate a second overcurrent signal (OC_UPPER) when an overcurrent is detected at the second measuring resistor (242).

16. The motor according to claim 15, wherein
the first and the second holding element (164, 154) are respectively connected to the control circuit (280), which is configured to switch off the power stage of the motor, upon reception of at least one of the first and the second overcurrent signals (OC_LOWER, OC_UPPER).

17. The motor according to claim 1, wherein generation of the overcurrent signal (OC_UPPER, OC_LOWER) by the overcurrent measuring element (152, 162) from the sensed value is accomplished within 500 ns.

18. A method of controlling an electronically commutated motor having:
a rotor (208) and a stator (201) for interacting electromagnetically with the rotor (208), which stator is equipped with a stator winding arrangement (201); and
a power stage (122) for controlling the currents flowing in the stator winding (202, 204, 206) during operation; comprising the steps of:
A) measuring a current value for at least one current (I UPPER; I LOWER) flowing in the power stage (122);
B) comparing said measured current value to a predetermined limit value (I_MAX_UPPER; I_MAX_LOWER);
C) if the measured value exceeds the predetermined limit value, determining the absolute value of the difference between said measured and limit values, and designating said absolute value as an overcurrent;
D) upon occurrence of an overcurrent, generating an overcurrent signal (OC_UPPER, OC_LOWER);
E) storing the overcurrent signal; and
F) delivering a signal corresponding to the overcurrent signal to the power stage (122), in order to counteract the overcurrent there.

19. The method according to claim 18, further comprising,
upon occurrence of said overcurrent signal, storing said overcurrent signal for a predetermined time period.

20. The method according to claim 18, further comprising
generating a reset signal (RESET UPPER, RESET LOWER) in order to cancel the overcurrent signal.

21. The method according to claim 20, further comprising
automatically generating said reset signal (RESET UPPER, RESET LOWER) a predetermined time period after receipt of said overcurrent signal.

22. The method according to claim 20, further comprising generating said the reset signal (RESET UPPER, RESET LOWER) in response to an external instruction.

23. The method according to claim 18, further comprising, upon occurrence of an overcurrent, switching off the power stage (122), in order to prevent said overcurrent from damaging the motor and its control circuits.
